(19) United States
(12) Patent Application Publication
(10) Pub. No.: US 2007/0262598 A1
(43) Pub. Date: Nov. 15, 2007

(54) Vacuum gripper

(75) Inventors: Walter Schaaf, Freudenstadt-Gruental (DE); Volker Moll, Lossburg-Wittendorf (DE); Tobias Stahl, Dornstetten (DE)

Correspondence Address: DREISS, FUHLENDORF, STEIMLE & BECKER, POSTFACH 10 37 62, D-70032 STUTTGART, DE

(73) Assignee: J. Schmalz GmbH, Glatten (DE)

(21) Appl. No.: 11/702,126

(22) Filed: Feb. 5, 2007

(30) Foreign Application Priority Data
Feb. 6, 2006 (DE) 102006005872.0-22

(51) Int. Cl. B25B 11/00

(52) U.S. Cl. 294/64.1

(57) ABSTRACT

The invention concerns a vacuum gripper for suctioning workpieces with an vacuum port, an elastic vacuum element and a vacuum element holder, wherein the vacuum element has a sealing lip on its side facing the workpiece, which delimits the vacuum chamber, and the vacuum chamber is flow-connected to the vacuum port, wherein the vacuum gripper has means that display the suction state, whose color changes.

This application claims Paris Convention priority of DE 10 2006 005 872.0 filed Feb. 6, 2006 the complete disclosure of which is hereby incorporated by reference.

### BACKGROUND OF THE INVENTION

The invention concerns a vacuum gripper for suctioning workpieces, comprising a vacuum port, an elastic vacuum element and a vacuum element holder, wherein the vacuum element has a sealing lip on its side facing the workpiece, which seals a vacuum chamber, and the vacuum chamber is flow-connected to the vacuum port.

Vacuum grippers are used for suctioning objects or workpieces to thereby either fix and/or handle them. When the vacuum grippers are located on manipulators, the suctioned object can be transported. It is thereby important that the object is correctly suctioned and the underpressure in the vacuum chamber is sufficiently high to ensure that the object is reliably held. Vacuum sensors are used to determine the underpressure. They are provided in the vacuum line to the vacuum gripper and pass on the detected value to a machine control which switches off the underpressure source when the desired underpressure has been reached, or blocks off the vacuum line. When the underpressure is not obtained, the vacuum gripper may be faulty or worn, and must be replaced.

It is therefore the underlying purpose of the present invention to design a vacuum gripper of the above-mentioned type which is inexpensive and clearly indicates whether or not it is still fully operative.

### SUMMARY OF THE INVENTION

This object is achieved in accordance with the invention by a vacuum gripper of the above-mentioned type in that it has means that indicate the state of wear, whose color changes.

The inventive vacuum gripper permits detection of a faulty vacuum gripper or, in particular, vacuum element, before determining that an underpressure can no longer be obtained, since e.g. the sealing lip fails to tightly seal the vacuum chamber or the suction element has become porous.

The wear limit is detected at an earlier time, since the vacuum gripper has means that indicate its state of wear via a change in color. For this reason, measures can be taken at an early stage before the vacuum gripper fails, to prevent any malfunction during suctioning of the workpiece, e.g. in consequence of insufficient underpressure. It is particularly advantageous to display the state of wear of the vacuum grippers that are subjected to wear, in particular, to maintain safety in production plants.

In one embodiment, the means comprise an element that is worn or abraded during use of the vacuum gripper. The state of wear can be detected or displayed on or via this element that is subjected to wear. This element that is subjected to wear is thereby e.g. subjected to abrasion, wherein the element is advantageously disposed in the area of the sealing lip, i.e. in the area that engages or abuts the workpiece to be suctioned.

In another embodiment, the vacuum element has, at least in sections, an element whose color changes with time or with the number of alternating stress or through application of an underpressure. This color change displays the state, in particular, the state of wear of the vacuum gripper. It may show e.g. the age of the vacuum gripper, whether the vacuum gripper has been frequently or rarely used, or whether or not the desired underpressure is applied to the vacuum gripper to achieve the desired suctioning force.

Further advantages, features and details of the invention can be extracted from the dependent claims and the following description which shows in detail particularly preferred embodiments with reference to the drawing. The features shown in the drawing and mentioned in the description and the claims may thereby be essential to the invention, either individually or collectively in arbitrary combination.

### BRIEF DESCRIPTION OF THE DRAWING

FIG. 1 shows a cross-section through a vacuum gripper;

FIG. 2 shows a schematic representation of a vacuum gripper with a colored coating;

FIG. 3 shows a schematic representation of a vacuum gripper comprising a material whose color changes; and

FIG. 4 shows a schematic representation of a vacuum gripper whose color changes at a certain underpressure.

### DESCRIPTION OF THE PREFERRED EMBODIMENT

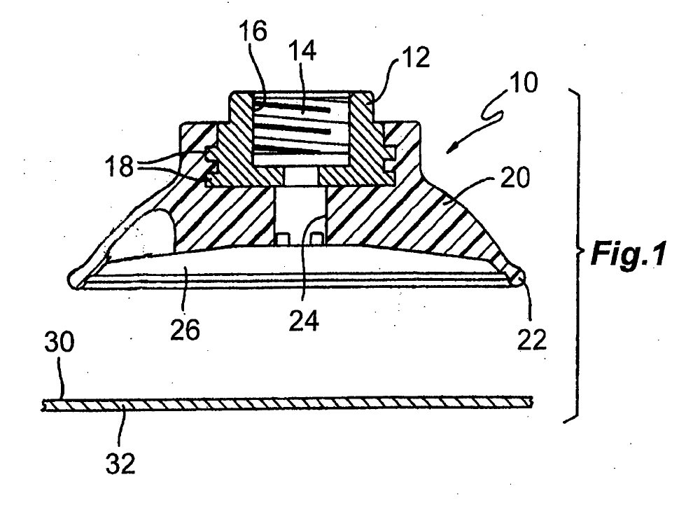

FIG. 1 shows a cross-section through a vacuum gripper that is designated in total with 10. Reference number 12 designates a vacuum element holder. It has a vacuum port 14 with e.g. an inner thread 16. The outer side of the vacuum element holder 12 has two peripheral beads 18 to which an elastic vacuum element 20 is securely fixed. This vacuum element 20 is approximately bell-shaped and has a circumferential lower edge which is formed as a sealing lip 22. The vacuum element 20 also has a central opening 24 which communicates with the vacuum port 14. The opening 24 terminates in a vacuum chamber 26 which is surrounded by the sealing lip 22 which is disposed onto the surface 30 of a workpiece 32.

The right-hand sides of FIGS. 2 through 4 each show the worn state of the vacuum gripper 10.

In FIG. 2, the suction element 20 has a colored coating 38 which is gradually worn in the area of the sealing lip 22 which is designed as a wearing element 40 and is supported on the surface 30 of a workpiece 32. When the coating 38 has been completely removed from the supported location, the material 42 below the coating 38 is visible, which has a different color, thereby indicating the wear limit.

FIG. 3 shows an embodiment, in which the vacuum element 20 is produced from a plastic material, whose color changes over time. In this fashion, the age of the vacuum gripper 10 can be displayed irrespective of its use. The vacuum gripper 10 or the vacuum element 20 can also be provided with a sticker 44 whose color changes with time. The color change may e.g. be caused by the influence of oxygen or UV light.

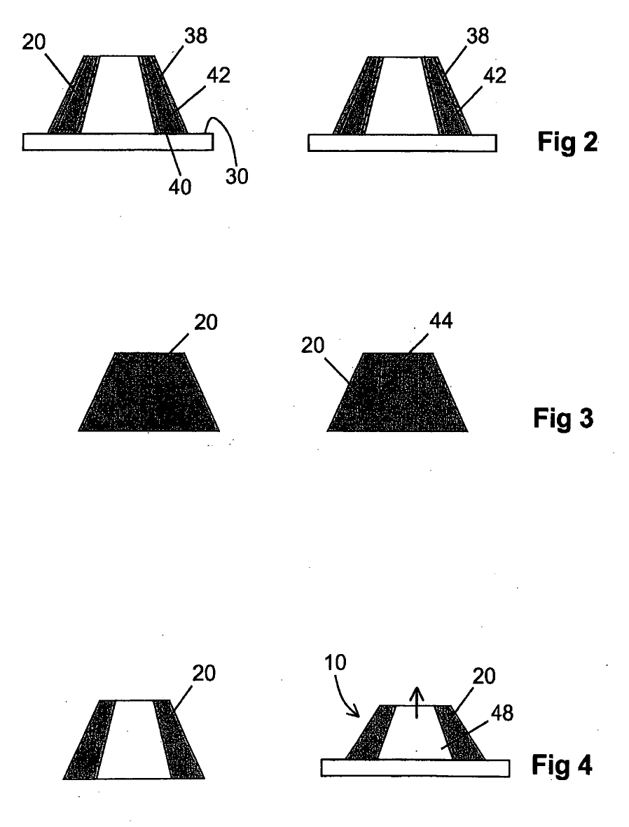

In FIG. 4, the material of the vacuum element 20 consists of a colored plastic material which changes its color at a certain underpressure. When the vacuum gripper 10 does not reach this underpressure, the color does not change which, in turn, determines that the wear limit has been reached. Reference numeral 48 designates the underpressure in the vacuum gripper 10.

The inventive vacuum gripper 10 determines the wear limit in a simple fashion, and the vacuum gripper 10 can be replaced before the wear limit is reached.

We claim:

1. A vacuum gripper for suctioning a workpiece the gripper comprising:
a vacuum port;
an elastic vacuum element having a sealing lip on a side facing the workpiece, said sealing lip delimiting a vacuum chamber, said vacuum chamber being flow-connected to said vacuum port;
a vacuum element holder disposed between said vacuum element and said vacuum port; and
means for detecting or displaying a state of wear, said detecting or displaying means having a color which changes in response to a state of wear.

2. The vacuum gripper of claim 1, wherein said detecting or displaying means have a wear element that is worn during use of the vacuum gripper.

3. The vacuum gripper of claim 2, wherein said wear element is subjected to a removal of material.

4. The vacuum gripper of claim 2, wherein said wear element is disposed proximate said sealing lip.

5. The vacuum gripper of claim 2, wherein said wear element has a coating of another color.

6. The vacuum gripper of claim 2, wherein said wear element comprises another or a differently colored plastic material and/or said vacuum element is a two-component injection-molded part.

7. The vacuum gripper of claim 1, wherein at least sections of said vacuum element comprises a color element, whose color changes with time, with a number of load changes, or after application of an underpressure.

8. The vacuum gripper of claim 7, wherein said color element is said vacuum element itself or part of said vacuum element.
